(19) United States
(12) Patent Application Publication
(10) Pub. No.: US 2013/0095901 A1
(43) Pub. Date: Apr. 18, 2013

(54) Multi-Dimensional Structure

(71) Applicant: Pantazis Houlis, Mount Lawley (AU)

(72) Inventor: Pantazis Houlis, Mount Lawley (AU)

(21) Appl. No.: 13/805,446

(22) PCT Filed: Jun. 30, 2011
(86) PCT No.: PCT/IB2011/001527

§ 371 Date: Dec. 19, 2012

(30) Foreign Application Priority Data
Jul. 1, 2010 (SG) 201004804-9

(51) Int. Cl. G09B 23/00; A63F 9/24; G09B 5/00; A63F 9/08

(52) U.S. Cl. CPC G09B 23/00; A63F 9/08; A63F 9/24; G09B 5/00
USPC 463/9; 273/153 S; 434/276; 29/428

(57) ABSTRACT

A multi-dimensional structure 100 is disclosed herein. In a first embodiment, the multi-dimensional structure is configurable as a Pentachoron structure 101 having a plurality of independent geometric structures 200,300,400. Each geometric structure is defined by a number of vertices A₁,A₂,B₁,B₂,C₁,C₂,D₁,D₂,E₁,E₂ cooperating with respective elongate members 202,302,402. The multi-dimensional structure 100 also comprises a plurality of structural vertices A₁+A₂, B₁+B₂, C₁+C₂, D₁+D₂, E₁+E₂, with each structural vertex comprising at least two vertices A₁,A₂,B₁,B₂,C₁,C₂,D₁,D₂,E₁,E₂ from respective geometric structures 200,300,400 movably connected together.

### BACKGROUND AND FIELD OF THE INVENTION

This invention relates to a multi-dimensional structure, particularly but not exclusively to a multi-dimensional game or puzzle apparatus.

Puzzles are known for generations and they are popular with adults and kids alike because they stimulate creative thinking and provide an intellectual challenge to the player. Rubik's Cube™ is an example of a successful and popular spatial puzzle.

It is an object of the present invention to provide multi-dimensional structure which provides the public with a useful choice.

### SUMMARY OF THE INVENTION

In a first aspect, there is provided a multi-dimensional structure comprising a plurality of independent geometric structures, each geometric structure being defined by a number of vertices cooperating with respective elongate members; a plurality of structural vertices, each structural vertex comprising at least two vertices from respective geometric structures movably connected together, the elongate members and the vertices defining a plurality of planar faces of the multi-dimensional structure, at least some of the elongate members being extendable and compressible to enable movement of a said structural vertex through at least one of the planar faces to create different multi-dimensional structures.

The plurality of independent geometric structures may be selected from the group consisting of triangles, squares, pentagons, hexagons, heptagons and octagons. Each vertex may include a sleeve member for cooperating with respective elongate members. The sleeve member may be a tube.

The at least two vertices may be movably connected together using an elastic element. The elastic element may comprise at least one O-ring. Instead of an elastic element, the at least two vertices may be movably connected together using magnetic force.

Preferably, the elongate members are telescopic, so that the structure is easy to manufacture.

The plurality of geometric structures and structural vertices may be configurable to form a geometric array inter-disposed within a further geometric array. The plurality of geometric structures and structural vertices may be configurable to form a Tesseract structure or a Tetrahedral prism structure. The geometric structures and structural vertices may also be configurable to form the general shape of a Platonic or Archimedean solid. Indeed, the geometric structures and structural vertices may be configurable to form any polytope.

Preferably, at least some of the elongate members and vertices carry a visual representation. In this way, if the structure is configured as a puzzle, the visual representation may be used to guide a user to solve the puzzle. The visual representation may include colours or characters.

The maximum effective length of each of the elongate members when fully extended may be different to create a more challenging and interesting structure. In the alternative or in addition, the minimum effective length of each of the elongate members when fully compressed may be different. The elongate members may also have different effective lengths to allow only specific moves and make the multi-dimensional structure more challenging.

The multi-dimensional structure may be adapted as a game apparatus or a puzzle comprising such an apparatus.

The multi-dimensional structure may be adapted in electronic form which includes physical limitations of a physical product and this forms second aspect of the invention in which there is provided a virtual multi-dimensional structure comprising a plurality of independent virtual geometric structures, each geometric structure being defined by a number of virtual vertices cooperating with respective virtual elongate members; a plurality of virtual structural vertices, each structural vertex comprising at least two virtual vertices from different virtual geometric structures movably connected together, the virtual elongate members and the virtual vertices defining a plurality of planar faces of the multi-dimensional structure, at least some of the virtual elongate members being extendable and compressible to enable movement of a said virtual structural vertex through at least one of the faces to create different virtual multi-dimensional structures.

Preferably, an interactive electronic game may comprise the virtual dimensional structure of the second aspect. The electronic game may be implemented online.

A third aspect of the present invention relates to a method of assembling a multi-dimensional structure, and this comprises the steps of:

defining a plurality of independent geometric structures which form the multi-dimensional structure, each geometric structure being defined by a number of vertices cooperating with respective elongate members; forming a plurality of structural vertex, each structural vertex formed by connecting at least two vertices from respective geometric structures moveably together; defining a plurality of faces of the multi-dimensional structural using the elongate members and the vertices, wherein at least some of the elongate members are extendable and compressible to enable movement of a said structural vertex through at least one of the faces to create different multi-dimensional structures.

A fourth aspect of the invention relates to a method of constructing a multi-dimensional structure made up of a plurality of geometric shapes, the method comprises the steps of:

(i) selecting a first geometric shape; (ii) mapping from the plurality of geometric shapes as many of the first geometric shapes as possible; (iii) if there are still unmapped geometric shapes; (iv) selecting a second geometric shape; (v) mapping from the unmapped geometric shapes as many of the second geometric shapes as possible; (vi) constructing a multi-dimensional structure based on the mapped first geometric shape and/or the mapped second geometric shapes; the first geometric shape being a smallest possible geometric shape of the plurality of geometric shapes.

The smallest possible geometric shape may be defined as a shape which includes all types of edges of the plurality of geometric shapes. Preferably, step (iv) includes forming a geometric structure based on the first geometric shape, the geometric structure being defined by a number of vertices cooperating with respective elongate members. Each of the elongate members may be extendable and compressible, such as telescopic elongate members.

Preferably, the first or second geometric shape is selected from the group consisting of triangle, square and pentagon.

It should be appreciated that the features discussed above and further explained in the description may be used for any of the aspects of the invention.

### BRIEF DESCRIPTION OF THE DRAWINGS

An embodiment of the invention will now be described, by way of example, with reference to the accompanying drawings in which,

FIG. 1 shows a multi-dimensional structure configurable as a Pentachoron structure according to a first embodiment of the present invention;

FIG. 2 shows geometric structures which form the Pentachoron structure of FIG. 1 which comprises two triangle structures and a square structure;

FIG. 3 are close-up views showing how two vertices of respective geometric structures of FIG. 2 are connected together to form a structural vertex for the Pentachoron structure;

FIG. 4 shows an alternative way of connecting the two vertices of FIG. 3;

FIG. 5 comprising FIGS. 5a-5h show various movements to transform the Pentachoron structure of FIG. 1;

FIG. 6 comprising FIGS. 6a-6e shows a second embodiment of the multi-dimensional structure configurable as a Tesseract structure;

FIG. 7 comprising FIGS. 7a and 7b shows the Tesseract structure of FIG. 6 and geometric structures which form the Tesseract structure;

FIG. 8 shows a third embodiment of the multi-dimensional structure configurable as a Tetrahedral prism; and

FIG. 9 is a Tesseract structure, similar to the one shown in FIG. 6, but with a face covered by a mesh.

### DETAILED DESCRIPTION OF THE PREFERRED EMBODIMENT

FIG. 1 shows a multi-dimensional structure 100 in the form of a Pentachoron structure 101 according to a preferred embodiment of the present invention.

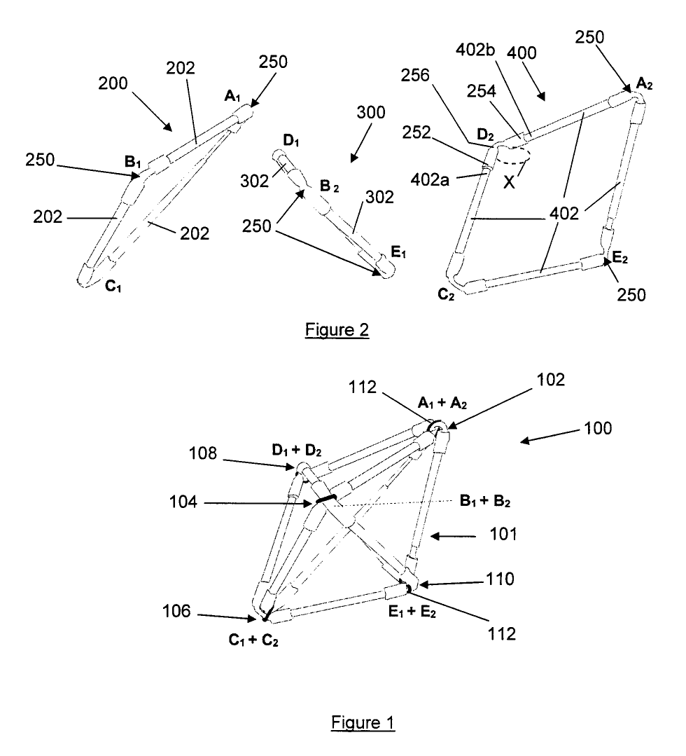

The Pentachoron structure 101 is a 4-dimensional object with five structural vertices 102,104,106,108,110 and this is formed by three geometric structures 200, 300, 400, and FIG. 2 is a disassembled view of the multi-dimensional structure 100 showing the geometric structures 200,300,400 separately.

The first geometric structure 200 has three vertices A₁, B₁, C₁ connected by elongate members 202 to define a triangle. Likewise, the second geometric structure also has three vertices D₁, B₂, E₁ and elongate members 302 arranged in a triangle. The third geometric structure 400 has a square shape and has four vertices A₂, E₂, C₂, D₂ and four elongate members 402.

A sleeve member 250 is used to connect adjacent elongate members 202,302,402 in an end-to-end arrangement at each vertex A₁, B₁, C. D₁, B₂, E₁, A₂, E₂, C₂, D₂. Taking the vertex D2 as an example (since the rest of the vertices are the same), the sleeve member 250 is a plastic flexible tube with two open ends 252,254 with each end adapted to receive respective ends 402a,402b of the adjacent elongate members 402. The tube's diameter (when not expanded) is slightly smaller than the diameter of the elongate member 402 and due to its elasticity, the open ends 252,254 are expandable to receive the ends 402a,402b so that the ends 402a,402b fits snugly therein and may not be released under normal use. The ends 402a,402b of the respective elongate members 402 are received inside the sleeve member 250 but leaving a gap 256 in the sleeve member 402 and due to the flexible material of the tube, the dimension of this gap 256 is slightly smaller than the diameter of those parts of the sleeve member which fits over the ends 402a,402b. The reason for this is explained below.

The flexible and elastic nature of the sleeve member 250 also allows relative angles between adjacent elongate members 202,302, 402 to be changed when the elongate members 202,302,402 are extended or minimised. For example, angle X between the ends 402a,402b is configured to change if the elongate member 402 with the end 402b changes the effective length with the elongate member 402 with the end 402a maintaining its effective length.

In this embodiment, the elongate members 202, 302, 402 of each of the geometric structure 200,300,400 are cylindrical and telescopic so that each elongate member 202, 302, 402 is extendable and retractable to change its effective length, and also the size and shape of each of the geometric structures.

The vertices A₁, B₁, C₁, D₁, B₂, E₁, A₂, E₂, C₂, D₂ of the geometric structures 200,300,400 are connected together so that at least one vertex of one geometric structure is movably connected to at least another vertex of another geometric structure to form the Pentachoron structure 101 shown in FIG. 1. It can also be appreciated that how the vertices are movably connected together are denoted by the pairing of the vertices based on A₁+A₂, B₁+B₂, C₁+C₂, D₁+D₂ and E₁+E₂, with each of these connections forming the respective structural vertices 102,104,106,108,110.

The pairs of vertices A₁+A₂, B₁+B₂, C₁+C₂, D₁+D₂ and E₁+E₂ are movably connected together using elastic O-rings 112 and FIG. 3 shows the connection more clearly using the D1+D2 structural vertex 108 as an example. As it can be appreciated from FIG. 3, the O-ring 112 ties the respective sleeve member 250 together at the gap 256. Since the gap 256 is slightly smaller than the diameter of those parts of the sleeve member 250 which fit over the elongate members 302,402, the movement of the O-ring 112 is restricted to the gap 256 so that despite the ability of rearranging the relative positions of the elongate members 302,402 and the structural vertices 102,104,106,108,110, it helps to keep the vertex pairs A₁+A₂, B₁+B₂, C₁+C₂, D₁+D₂, E₁+E₂ connected is together. At the same time, due to its elasticity, the O-rings 112 enable relative movement between the vertices A₁+A₂, B₁+B₂, C₁+C₂, D₁+D₂ and E₁+E₂ of different geometric structures 200,300,400 and also allow the angles at the vertices to change (for example, angle X as in FIG. 2) and this creates easier operation of the multi-dimensional structure 100.

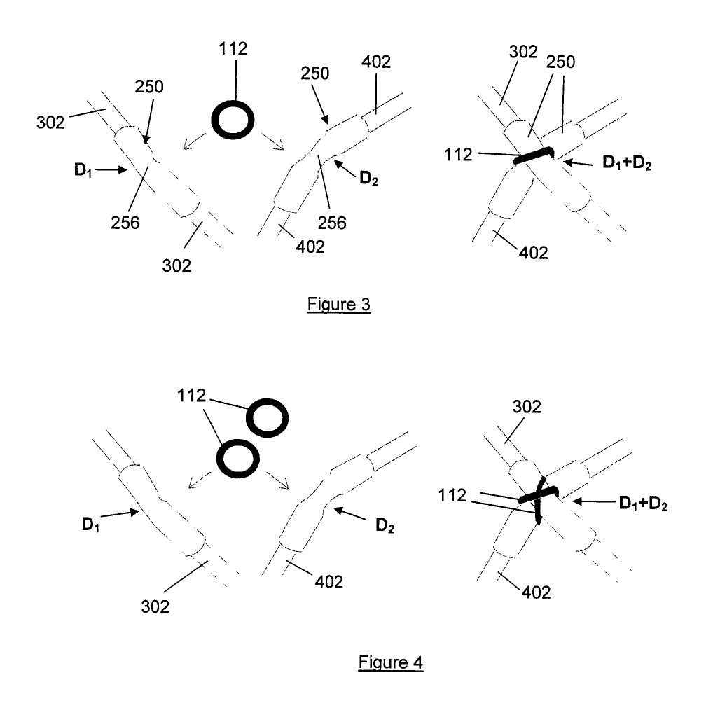

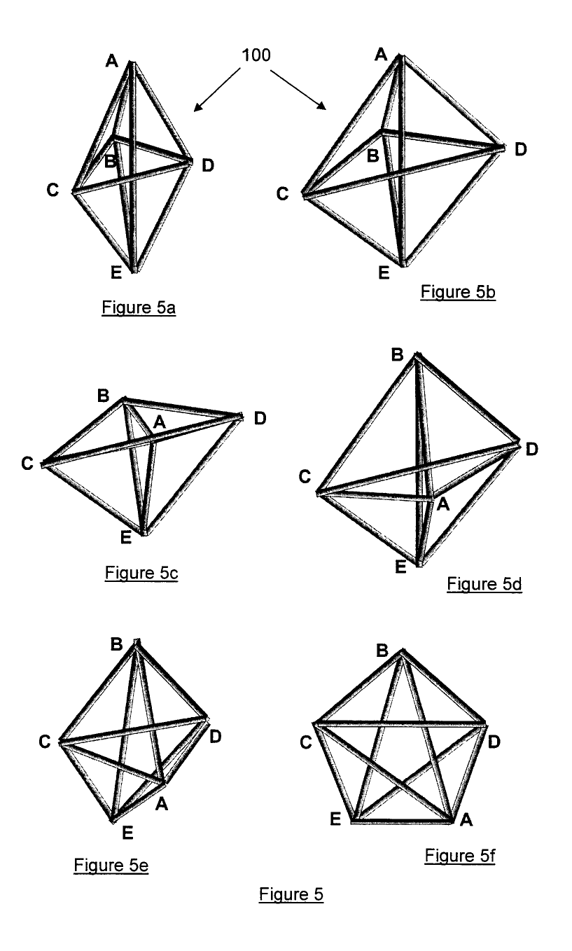

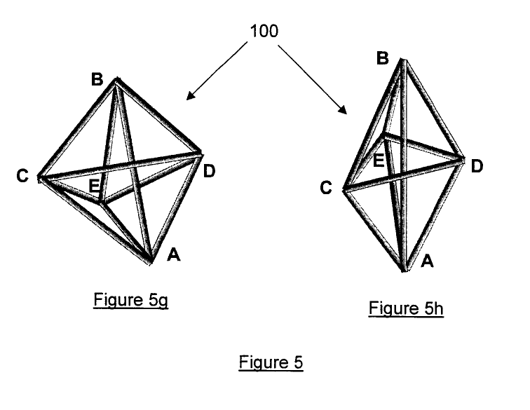

Instead of using one O-ring 112 to connect each vertex pair A₁+A₂, B₁+B₂, C₁+C₂, D₁+D₂, E₁+E₂, two or more O-rings 112, 114 may be used as shown in FIG. 4 to enhance the connection. In the alternative, other connectors may be used, such as a metal connector to couple each vertex pair together. FIG. 5 comprises FIGS. 5a-5h show various movements to transform the Pentachoron structure 101 of FIG. 1 but for ease of explanation, the Pentachoron structure 101 is shown in simplified form in FIG. 5. It should be explained that the structural vertices A, B, C, D, E shown in FIG. 5 correspond respectively to the vertex pairs A₁+A₂, B₁+B₂, C₁+C₂, D₁+D₂, E₁+E₂, and has ten faces (for example, the area bounded by structural vertices C,D,E of FIG. 5a define a face, and the area bounded by structural vertices A,C,D of FIG. 5a defines another face). Also, for the purposes of the explanation below relating to FIG. 5, the elongate members 202,302,402 will be referenced using the vertex references, for example, the elongate member CD means the elongate member which connects between the structural vertices C and D (i.e. between C₁+C₂ and D₁+D₂ of FIG. 1).

FIG. 5a shows a starting position of the vertices A,B,C,D,E (including the elongate members 202, 302, 402 which made up the Pentachoron structure 101). To transform the Pentachoron structure 101 from the shape shown in FIG. 5a to FIG. 5b, the elongate member CD is extended. Next, the corner A is lowered into the face defined by B,C,D to form the shape and structure shown in FIG. 5c.

To transform from the shape shown in FIG. 5c to the one shown in FIG. 5d, the elongate member AB is extended so that the structural vertex A reaches about the middle of the face C,D,E. Next, the vertex A is pulled to extend the effective lengths of the various elongate members which define that corner so that vertex A extends outwards of the face C,D,E to form the structure shown in FIG. 5e.

To transform from the shape and structure of FIG. 5e to that shown in FIG. 5f, the respective lengths of the elongate members CB, BD, DA, AE, and EC are minimised by retracting the elongate members CB, BD, DA, AE, and EC.

Next, the elongate members EB and ED are minimised or retracted to change the shape to the one shown in FIG. 5g. Finally, the elongate member CA and CD are also minimised to form the shape and structure shown in FIG. 5h. It should be appreciated that the structure of FIG. 5h is still the Pentachoron structure 101 similar to the one shown in FIG. 5a, except that the positions of some of the structural vertices A, B, E have changed.

As a result, the multi-dimensional structure 100 may be configured into different shapes and sizes. Indeed, the multi-dimensional structure 100 may be regarded as a game or a puzzle. To use it as a game apparatus, a user holds the multi-dimensional structure 100 in his hand and manipulates it for example by elongating or compressing the elongate members 202,302,402, and using the sleeve members 250 to change the angle of the elongate members 202,302,402 at the structural vertices 102,104,106,108,110. This causes the structure 100 to temporarily change shape as it can be appreciated from the above explanation, which allows a chosen structural vertex 102,104,106,108,110 to move through a chosen open face of multi-dimensional structure defined by three or more of the elongate members 202,302,402. The result of this movement is the change of position and/or orientation of the structural vertices with respect to the other vertices. With this arrangement, a simple and yet challenging game or puzzle may be created, for example if the structural vertices 102,104,106,108,110 are numbered and are required to be placed in a predetermined orientation of a predetermined shape (especially as there can be more than one shape for a specific number of elongate members and structural vertices). It is possible to have more than one vertex moving through the same face at the same time. This set of vertices and the compressed/extended) elongate members they have in common, may also determine an entire edge or face which fits to pass through the face defined by the elongate members.

Through playing the puzzle, a player can explore the relationship between three-dimensional space and two-dimensional planar or non-planar structures such as graphs in graph theory, the interrelation of inner and outer space characteristics, their specific features and regularities. It is envisaged that there may even be structures based on Cayley graphs which examine special algebraic and symmetrical properties. Such structures may be used for games, for finding shortest route (in terms of number of elongate members), the famous graph theory colouring problem, and in general for assistance in teaching of graph theory. The elongate members may also represent directional graphs. Such a puzzle also has considerably wide range of choices between possible step variations so that the player may entertain himself while the puzzle maintains his attention and improves his mechanical aptitude simultaneously. The players' hand and eye coordination skills may be improved and supports kinaesthetic learning process. As a result, such a puzzle is not only educational but also fun.

It can also be appreciated that in the course of playing, the solution of the puzzle is altered by rearranging, through any sequence of steps, the structural vertices 102,104,106,108,110. Following this, the goal of the game may lie in arriving at the initial or predetermined regular specific pattern, possibly and preferably within the shortest period of time, i.e. by performing, out of a large number of variations, the shortest sequence of steps through which the vertices 102,104,106,108,110 and the elongate members 202,302,402 are placed into a predetermined position. Arriving at a pre-determined specific pattern of the puzzle elongate members and structural vertices 102,104,106,108,110 may prove to be a hard task despite the fact that handling the puzzle seems, at least at first instance, to be easy, resulting in a challenging puzzle.

While handling the multi-dimensional structure with an aim of solving the puzzle, the player is confronted with questions regarding the relationship between a three-dimensional space and planer structures contained and moved therein. Moreover, the structure allows the construction of graphs which are equivalent to the projection of four-dimensional (or higher) structures. Time is then used as the fourth dimension to guide the player through many projections of higher dimensions to the three dimensions, which may give an experience of the fourth dimension. The constructed structures may be regarded as objects of higher dimensions (e.g. 4th), as the represent projection. By manipulating the elongate members 202,302,402 and the vertices 102,104,106,108,110 it may be possible to see as many projections as possible of a high dimensional object in the three dimensions, and this provides a better understanding of higher dimensions. A higher (than three) dimensional puzzle may then be constructed for transforming the object from one three dimensional projection to another.

Problems of interrelating the senses of the vertices 102,104,106,108,110 and the elongate member movements, the reversibility of coordinate systems, and the terms of “outside” and “inside” may gradually become more and more apparent to regular and enthusiastic users of the puzzle.

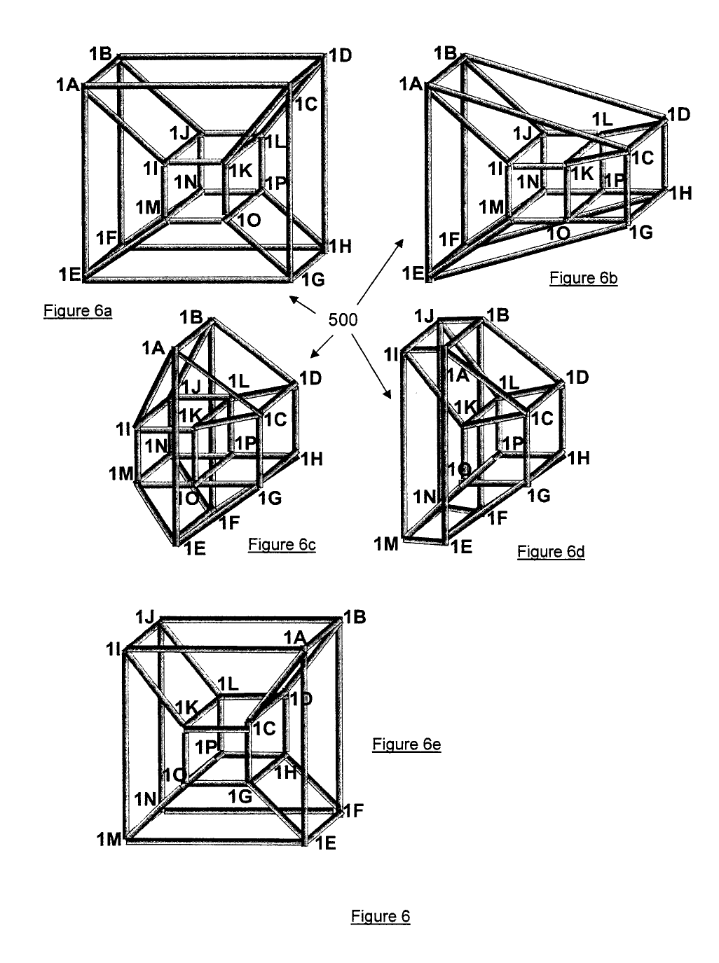

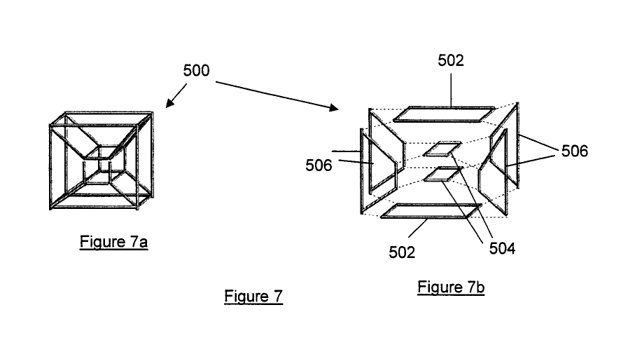

A second embodiment of the multi-dimensional structure 100 is a Tesseract structure 500 which is an 8-cell or regular octachoron. The Tesseract structure 500 is also called a hypercube (or more specifically 4-cube). FIG. 6 comprising FIGS. 6a-6f shows how to transform such a Tesseract structure 500 which is shown in FIG. 6a. It should be appreciated that the Tesseract structure 500 is formed from elongate members 202,302,402 similar to that for the Pentachoron structure and which are connected at their ends by sleeve members 250 to form basic geometric structures and then vertices of the geometric structures are connected together using O-rings 112 to form structural vertices of the Tesseract structure 500 in a similar manner as that described for the Pentachoron structure 101. The Tesseract structure 500 of FIG. 6a is reproduced in FIG. 7a and FIG. 7b shows a disassembled view which shows the basic geometric structures of two rectangles 502, two squares 504 and four trapeziums 506.

Starting with FIG. 6a, elongate members defining the square 1C, 1D, 1H and 1G are compressed to form the structure shown in FIG. 6b. Next, to transform from FIG. 6b to FIG. 6c, the four structural vertices 1I, 1M, 1N, and 1J are moved through the square face defined by structural vertices 1A, 1B, 1F and 1E. The elongate members defining the square 1I, 1M, 1N and 1J are then extended to form the structure shown in FIG. 6d. Finally, to transform from FIG. 6d to FIG. 6e, the four elongate members 1I-1A, 1J-1B, 1M-1E, and 1N-1F are extended so that the cube defined by the vertices 1K, 1L, 1C, 1D, 1O, 1P, 1G and 1H are now located inside the larger cube defined by the to vertices 1I, 1J, 1A, 1B, 1M, 1N, 1E and 1F. As it can be appreciated from FIG. 6e, the Hypercube has the same shape as that shown in FIG. 6a, but the structural vertices 1A, 1B, 10, 1D, 1H, 1G, 1E, 1F, 1I, 1J, 1N, 1M, 1L, 1P, 1O, 1K are positioned in different places.

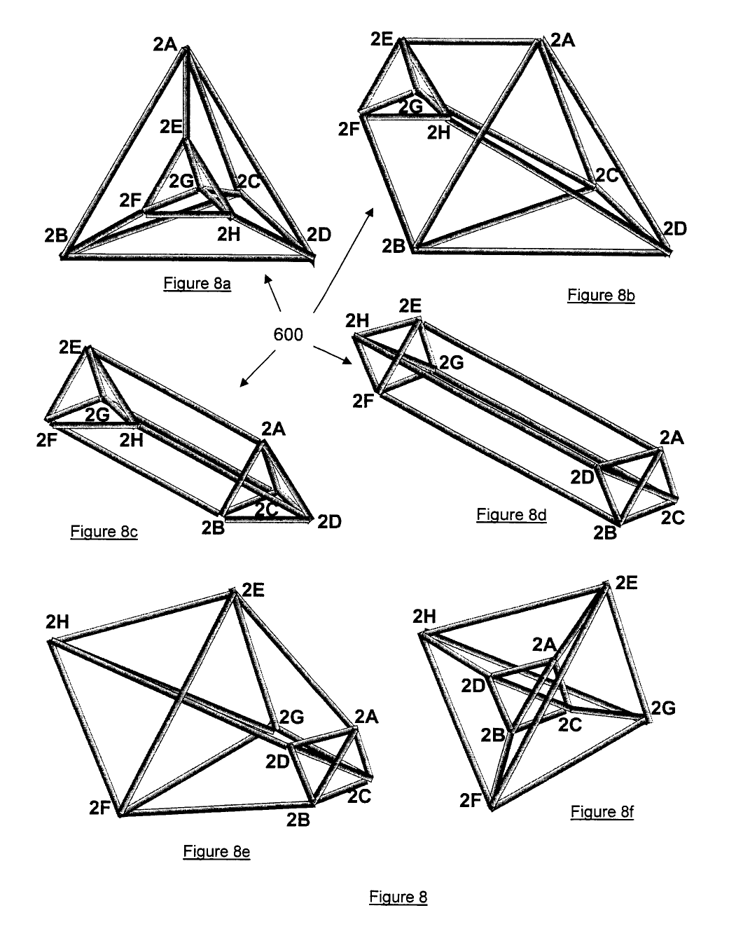

is As another example, the apparatus 100 may also be configurable as a Tetrahedral prism 600, which is a third embodiment of the present invention. The Tetrahedral prism 600 is shown in FIG. 8a and FIG. 8 which comprises FIGS. 8a-8f show how to transform the Tetrahedral prism 600. Starting with FIG. 8a, the inner tetrahedron defined by corners or structural vertices 2E, 2F, 2G, and 2H is moved through the triangular face defined by structural vertices 2A, 2B, and 2C to form the structure of FIG. 8b. This also means that the elongate member 2H-2D (i.e. the elongate member between vertices D2 and 2D) is extended. Next, the six elongate members of the tetrahedron defined by the corners 2A, 2B, 2C, and 2D are compressed to form the structure of FIG. 8c. From FIG. 8c, the corner 2H is moved through the triangular face 2E-2F-2G and the corner 2D is also moved through the triangular face 2A-2B-2C to form the structure of FIG. 8d. To transform from FIG. 8d to FIG. 8e, the six elongate members defined by the tetrahedron with corners 2E, 2H, 2F and 2G are enlarged (by extending the respective elongate members —for example the elongate member 2H-2E (the elongate member between corners 2H and 2E)). Finally, the rod 2H-2D is compressed to cause the small tetrahedron defined by the corners 2A, 2B, 2C, and 2D to be located inside the large tetrahedron defined by the corners 2E, 2F, 2G, and 2H. Again, the structural vertices of the Tetrahedral prism 600 have been relocated.

It should be noted that during the above transformation processes, some other elongate members may slightly compress or extend. This is normal, and it is all part of moves shared by connected elongate members/rods, so some may affect others.

Just like the Pentachoron structure 101 and the Tesseract structure 500, the Tetrahedral prism structure 600 is constructed from basic geometric structures. It would be appreciated that the various geometric structures may be used to form the multi-dimensional structure 100 and the following steps proposes how:

The method for construction:

(1) the multi-dimensional structure 100 is first divided or mapped into as many triangular shapes or faces as possible, if any, which can share corners/vertices, but not elongate members.

(2) Next, the structure 100 is divided into as many square shapes as possible, if any, which can share corners/vertices but not elongate members.

(3) Thereafter, the puzzle is divided into as many pentagon shapes as possible, if any, which can share corners/vertices but not elongate members.

(4) The above procedure is repeated for hexagons, heptagons, and in general polygons with n rods, until the configuration of the entire structure is represented by geometric shapes.

After the division is completed, geometric structures are created based on the geometric shapes using elongate members and the geometric structures are connected with circular joints at the vertices. Finally, if there are an odd number of elongate members connected to a corner, that corner may be connected with an additional single elongate member, which may be telescopic. This is because preferably there are even numbers of elongate members which are connected to a corner or vertex, and if there are an odd number of elongate members, then it is not paired. In other words, it is preferred for a vertex to have an even number of elongate members passing through it. However, it is not preferred to connect a single elongate member to an existing elongate member.

The above steps in selecting a geometric shape to begin construction of the structure are applicable in most circumstances. However, in some circumstance, more thought is needed on selecting the first geometric shape to start the mapping process.

Take the example of the Tetrahedral prism structure 600 shown in FIG. 8. If the above mapping steps are followed, this would result in using independent geometric structures having the shapes of a triangle, a pentagon, and an octagon to create the prism structure 600, the triangle being the smallest possible shape. However, this is not the most efficient since this leads to twist which reduces flexibility of movement of the structural vertices of the structure. Thus, instead of simply the smallest possible shape, the smallest possible shape may be defined as one which also includes all types of edges.

To elaborate on (1) above, it is not necessary a triangle but it is preferred to start with a smallest face which contains all different types of edges. In the case of a Pentachoron structure 101, it would be a triangle, and in the case of a Hypercube 500, it would be a square.

is It should be appreciated that in the Pentachoron structure 101, it is possible to swap the position of any elongate member with any other elongate member by finding an appropriate symmetrical transformation. This is because there is only one “type of elongate member”, and as a result, it would be appropriate to start with the smallest possible face which is a triangle. The same applies in the Hypercube structure 500, where any elongate member can again be swapped with any other elongate member. Of course, in the Hypercube structure 500, the smallest possible face is a square.

In the case of the Tetrahedral prism structure 600, there are two types of elongate members:

(a) the elongate members which form the two tetrahedrons (referring to FIG. 8a, the inner tetrahedron defined by vertices 2E, 2F, 2G, 2H and the outer tetrahedron defined by vertices 2A, 2B, 2C, 2D); and

(b) the elongate members which connect these two tetrahedrons.

It should be further appreciated that the elongate members in (b) such as elongate members 2A-2E, 2B-2F are part of a square, whereas to form the two tetrahedrons, triangles are needed. Not all of the elongate members which form the tetrahedral prism structure 600 are considered to be “edge-transitive”. It is preferred to include the two types of elongate members as part of the “smallest face” to begin the construction of the multi-dimensional structure to avoid unnecessary tangling (i.e. twisting around the other elongate members and the vertices) which may damage the elongate members. To put this differently, the smallest possible face should preferably include all types of edges (i.e. as defined by the elongate members), such that one of the edges of the smallest possible face may be mapped to an edge of the predetermined shape (e.g. tetrahedral prism) which is edge-transitive. With this revised definition of a smallest possible shape, the Tetrahedral prism structure 600 would then be divided into four square shapes which provide a more efficient operation of the structure.

It should be mentioned that the word “square” is used in the present application to mean a tetragon, be it regular or irregular.

Under such circumstances, the smallest face is one which contains all types of edges/elongate members.

The described embodiment should not be construed as limitative. In the embodiment, all the elongate members 202,302,402 of the geometric structures 200,300,400 are telescopic but this may not be so. For example, the elongate members 202,302,402 may be formed from materials which allow its effective length to change without being telescopic, such as using materials relying on the Poisson effect. For example, a negative Poisson ration would make the material thinner as the elongate member compresses, and thickens as the elongate member extends. A positive Poisson ration would make the elongate member become thicker as the elongate member compresses, and thinner as the elongate member is being extended. A zero ratio is one which preserves the thickness regardless of whether the elongate member compresses or extends.

Any suitable material may be used such as plastic or even paper. Metal may also be used but this may result in a delicate mechanism. Also, the effective length of some of the elongate members 202,302,402 may vary, or be fixed and not adjustable as long as it is possible to move the vertices through the faces. A combination of telescopic elongate members and non-telescopic ones may be used.

Also, in the described embodiments, triangles and squares are used as the basic geometric structures but other structures or shapes such as pentagons, hexagons, heptagons, octagons etc are also envisaged.

In the embodiments of FIG. 1, the Pentachoron structure 101 has the same valency i.e. the number of elongate members 202,302,402 extending from a structural vertex A,B,C,D,E is the same as the total number of structural vertices. However, this may not be necessary the case.

The elongate members 202,302,402 may change length, angle and position at the same time, to assist to a synchronised movement, such that no elongate member creates pressure on the vertices 102,104,106.108,110 and the multi-dimensional structure 100 maintains its overall structure. The elongate members 202,302,402 may also be of fixed length, as long as the corners/vertices allow the elongate members to shift/pass through them (this creates vertices with temporary extensions). Elongate members 202,302,402 are preferably of the same specification to preserve symmetry more efficiently. To increase the difficulty of operating or playing the game apparatus, the elongate members 202,302,402 may have variable sizes within the same apparatus.

Preferably, each elongate member 202,302,402 and/or vertex 102,104, 106,108,110 carries a visual representation, such that when the multi-dimensional structure 100 is properly arranged, the visual representation may represent a solution to a puzzle. The visual representation carried by each or at least some of the elongate members 202,302,402 and/or structural vertices may be identical. The visual representation may comprise colours or a combination of different colours to form a pattern.

It is also envisaged that the visual representation may comprise characters.

The plurality of elongate members 202,302,402 may be made of the same or different types of material and if the elongate members are telescopic materials such as wood, bamboo, plastic, or metal may be used. Preferably, the extended length is at least twice or thrice as long when compared to the maximum compressed length. The plurality of elongate members 202,302,402 may extend or turn in a rotational way, and their structure may be similar to that of a spring, straw, piston, tonkin, zig-zag shape, or coil.

“Elongate” does not necessarily mean “straight” but includes also a long member which is curved as long as it does not interfere with the expanding movement. For example, in the case of a Hypersphere, where to realise the puzzle, curved elongate members are needed. The elongate members may be locked or not, they can be smooth moving or hard to move, depending on the requirements of the puzzle. Preferably the colouring of the rods or the symbol embedding should be assisted by paint, spray, hand-bar tape, coil, or heat-shrink, tubes.

The sleeve members 250 may be made of plastic, metal or elastic material, and emphasis should be given in their ability to connect and position the elongate members to as many angles as possible. Preferably they should be flexible, and able to turn in universal directions. In the described first embodiment short n-way tubes are used; where n is equal or greater than two. Preferably, the vertices 102,104,106,108,110 should be able to allow interchange of the placement of the elongate members by using a sliding or exchanging mechanism.

Preferably, the sleeve member 250 should be spherical or cylindrical tubes. The sleeve member 250 is preferably made of slightly elastic and bendable material to enable a less complex and smooth movement.

However, it may be possible to calculate what is the best way of connecting the to elongate members so that no overlap occurs (this is to eliminate over-twisting of the top and bottom parts of the elongate members). This strategic arrangement of the rods may be done by using the smallest possible connected rod faces (CRF), which is then connected to all the other CRFs to assemble the entire structure/puzzle. In normal circumstances with efficient (regular) structures, they are triangles or squares (but they can be larger). The CRFs may then be connected with the simplest connectors (for example, a rubber-band, o-ring, or by using other stable enough connector).

The minimization of all internal (and not necessarily the external) rods, defines a unique shape for the structure/puzzle, regardless the number of vertices and edges. This shape may be used for the starting point for solving a puzzle, as well as the ending point, but this time with a different colour or symbol configuration. To elaborate, for a 3-dimenstional object (e.g. tetrahedrons), the object comprises external edges/elongate members only. However, when it comes to 4-dimensional objects, there are internal and external edges which are more complex. An interesting property of these external edges is that when minimised, the overall shape of the structure is maintained (the length of the internal edges are not material since the overall shape of the structure is dictated by the external edges).

Sometimes, a slightly different shape is chosen which is close to the external-minimised rods shape, while in some other cases all the external rods may be maximised. For example, in the Pentachoron structure 101, a good shape is achieved when all the external rods are minimised, while the middle one is elongated. In the Hypercube 500, the other extreme may be reached in that the external elongate members are maximised, while the internal ones are minimised. It is all about achieving a shape which is acceptable to become a good puzzle, and the most common rule is to minimise the external rods.

In the described embodiment, the elongate members 202,302,402 are telescopic and thus, their effective lengths may be adjusted. The telescopic function should provide sufficient friction to hold the member 202,302,402 at a particular length without changing to provide for a stable puzzle.

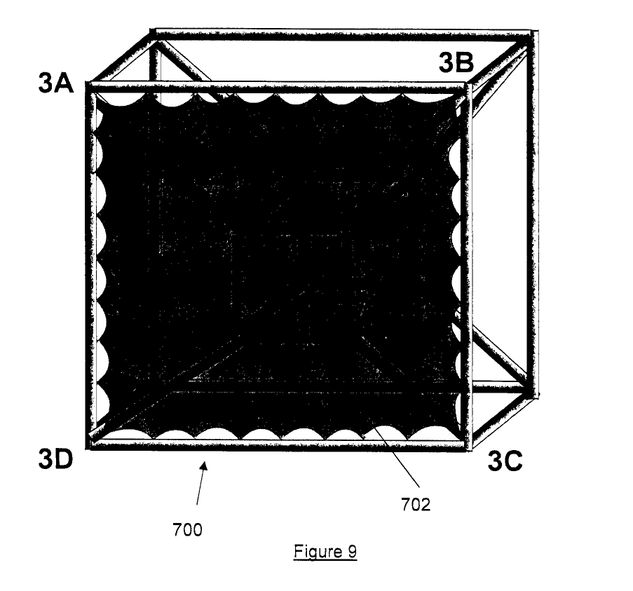

The same friction principle applies to the sleeve members. Some of the faces (or all of the faces) defined by the plurality of elongate members and the structural vertices may also be connected to any expandable and/or compressible mesh, net, grid, web, lattice, or a collection (connected or not) of other elastic or expandable elements. An example is shown in FIG. 9 which is a Tesseract structure 700, similar to the one shown in FIG. 6 and which has a mesh 702 connected to elongate members 3A-3B, 3B-3C, 3C-3D and 3D-3A and structural vertices 3A, 3B, 3C, 3D. In other words, the mesh 702 covers a face of the structure 700. Such a feature may provide a more solid appearance to the face, but at the same time, the face could not be used for moving the other corners through them. This can lead to more interesting puzzles which are bandaged, simpler, or more complex (depending on specifications), because it is possible to block specific paths of the sequential moves.

The multi-dimensional structure may have many shapes and sizes which is dictated by the number of elongate members and vertices and this may be appreciated the examples in FIGS. 6 and 8.

The plurality of elongate members and the vertices may be arranged to define the general shape of a Platonic solid, Archimedean solid, and any other three dimensional solid, including the projection of the four dimensional (or higher is dimensional) structures.

Instead of a physical device, it is also envisaged that the multi-dimensional structures 100,500,600 may be implemented virtually or electronically such as an electronic game. To play the virtual game, a user manipulates the virtual multi-dimensional structure, for example by elongating or compressing the elongate members electronically, and using the sleeve members 250 to change the angle of the elongate members 202,302,402. This causes the virtual game apparatus to temporarily change shape, which may allow a chosen vertex to move through a chosen open face of the virtual game apparatus determined by three or more elongate members. The result of this movement is the change of position of the vertex with respect to the other vertex.

The virtual game apparatus may be implemented on an interactive electronic game which may include a finger or hand controller to control the movement of the virtual game apparatus, thereby causing the virtual elongate members to extend and compress, and the sleeve members to change the angle of the elongate members. The interactive electronic game may be implemented online and may be also programmed as a multi-player game so that players compete against one another to solve the puzzle within the shortest period of time. The virtual game apparatus may also be implemented in a hand-held electronic gaming device.

It is further envisaged that the multi-dimensional structure, as a physical device, may be adapted as a fourth (or higher) dimensional “construction” game apparatus such that it projects the multiple reflections of the four dimensional structures into the three dimensional world. This is achieved by using the same structure for all projections, and by assuming time is the fourth dimension.

The present invention may be used games and advertisements, or it can be successfully used for other purposes, such as for decorative purposes.

1. A multi-dimensional structure comprising a plurality of independent geometric structures, each geometric structure being defined by a number of vertices cooperating with respective elongate members; a plurality of structural vertices, each structural vertex comprising at least two vertices from respective geometric structures movably connected together, the elongate members and the vertices defining a plurality of planar faces of the multi-dimensional structure, at least some of the elongate members being extendable and compressible to enable movement of a said structural vertex through at least one of the planar faces to create different multi-dimensional structures.

2. A multi-dimensional structure according to claim 1, the plurality of independent geometric structures is selected from the group consisting of triangles, squares, pentagons, hexagons, heptagons and octagons.

3. A multi-dimensional structure according to claim 1, wherein each vertex includes a sleeve member for cooperating with respective elongate members.

4. A multi-dimensional structure according to claim 3, wherein the sleeve member is a tube.

5. A multi-dimensional structure according to claim 1, wherein the at least two vertices are movably connected together using an elastic element.

6. A multi-dimensional structure according to claim 5, wherein the elastic element include at least one O-ring.

7. A multi-dimensional structure according to claim 1, wherein the at least two vertices are movably connected together using magnetic force.

8. A multi-dimensional structure according to claim 1, wherein the elongate members are telescopic.

9. A multi-dimensional structure according to claim 1, wherein the plurality of geometric structures and structural vertices are configurable to form a geometric array inter-disposed within a further geometric array.

10. A multi-dimensional structure according to claim 1, wherein the plurality of geometric structures and structural vertices are configurable to form a Pentachoron structure, a Tesseract structure or a Tetrahedral prism structure.

11. A multi-dimensional structure according to claim 1, wherein the geometric structures and structural vertices are configurable to form the general shape of a Platonic or Archimedean solid.

12. A multi-dimensional structure according to claim 1, wherein at least some of the elongate members and vertices carries a visual representation.

13. A multi-dimensional structure according to claim 12, wherein the visual representation includes colours or characters.

14. A multi-dimensional structure according to claim 1, wherein maximum effective length of each of the elongate members when fully extended is different.

15. A multi-dimensional structure according to claim 1, wherein minimum effective length of each of the elongate members when fully compressed is different.

16. A multi-dimensional structure according to claim 1, further comprising a mesh arranged to cover one of the planar faces.

17. A multi-dimensional structure according to claim 1, further comprising an elongate rod having its ends coupled to respective vertices.

18. Game apparatus comprising the multi-dimensional structure according to claim 1.

19. A puzzle comprising the game apparatus of claim 18.

20. A virtual multi-dimensional structure comprising a plurality of independent virtual geometric structures, each geometric structure being defined by a number of virtual vertices cooperating with respective virtual elongate members;
a plurality of virtual structural vertices, each structural vertex comprising at least two virtual vertices from different virtual geometric structures movably connected together, the virtual elongate members and the virtual vertices defining a plurality of planar faces of the multi-dimensional structure, at least some of the virtual elongate members being extendable and compressible to enable movement of a said virtual structural vertex through at least one of the faces to create different virtual multi-dimensional structures.

21. An interactive electronic game comprising the virtual dimensional structure of claim 20.

22. An interactive electronic game according to claim 21, wherein the electronic game is implemented online.

23. A method of assembling a multi-dimensional structure, comprising the steps of:
defining a plurality of independent geometric structures which form the multi-dimensional structure, each geometric structure being defined by a number of vertices cooperating with respective elongate members;
forming a plurality of structural vertex, each structural vertex formed by connecting at least two vertices from respective geometric structures moveably together;
defining a plurality of faces of the multi-dimensional structural using the elongate members and the vertices, wherein at least some of the elongate members are extendable and compressible to enable movement of a said structural vertex through at least one of the faces to create different multi-dimensional structures.

24-29. (canceled)
